(19) United States
(12) Patent Application Publication
(10) Pub. No.: US 2021/0224773 A1
(43) Pub. Date: Jul. 22, 2021

(54) AUTOMATIC PRODUCT IDENTIFICATION IN INVENTORIES BASED ON MULTIMODAL SENSOR OPERATION

(71) Applicant: E-VENTOR TECH KFT., Eger (HU)

(72) Inventors: István FAZEKAS, Egerszalók (HU); Csaba FAZEKAS, Eger (HU); Zsolt VASZARI, Dunakeszi (HU)

(21) Appl. No.: 17/259,823

(22) PCT Filed: Jul. 15, 2019
(86) PCT No.: PCT/HU2019/050034

§ 371 Date: Jan. 12, 2021

(30) Foreign Application Priority Data
Jul. 13, 2018 (CA) 3011318

(51) Int. Cl. G06Q 20/20; G06Q 10/08; G06K 9/00; G06K 7/14

(52) U.S. Cl. CPC G06Q 20/203; G06Q 20/208; G06K 7/1417; G06Q 10/087; G06K 9/00771; G06Q 20/206

(57) ABSTRACT

Disclosed is an automated product inventory management system, based on multimodal sensor operation, in particular an automated supervisor system and method to handle the inventory of product items, where products are tracked individually from the moment of entry into the inventory. Categorization is executed from the time the product enters the inventory, and during its residence therein by automated identification processes. The position of the product items in the inventory is detected automatically, and used to identify the product item. When the product item is removed from the inventory, its previous resting position will be the basis of a lookup for its individual record and the product category information.

### FIELD OF THE INVENTION

The invention relates to automatic inventory and an automated supervisor system to be used in conjunction with retail systems and processes of unattended nature.

### BACKGROUND ART

In general, to provide quantitative and monetary information of a retail process the essential detail is to have the correct product category assigned to an individual product, at the latest when a customer removes said product from the inventory.

In the following description, a couple of terms will be used with some specific meaning. For an unambiguous discussion, by way of introduction, the following definitions are provided.

Product item: an individual product or a piece of goods available on stock, i.e. in the inventory of a retail system.

Product identity: an individual product identification number (id number) or key, assigned to every single product item in the inventory.

Buyer: A person in a merchandising context, who consumes product items and provides a payment in return.

Client: A person in a generic context (including, but not limited to the merchandising context), who consumes or makes use of product items (e.g. a buyer or an employee).

Restocker: An agent of the operator of the point of sale with the main focus of refilling the product inventory with product items.

User: Any person in interaction with the system in subject, independently of the business model in which the inventory system is used.

Product identification: the process of assigning an individual product id number to a certain product item.

Product type: a collection of details used for inventory management, depending on the actual field of application, including but not limited to: a brand name, a generous barcode that unambiguously identifies the product item, the price of the product item, the weight of the product item, physical dimensions of the product item, a photo of the product item, and any other characteristics of the product item, on the basis of which a unique product id number associable with the product item for unambiguous identification of the particular product item can be defined. Here, the product type is represented by a product type identifier or key, that points to the table of the collection of details in a product database.

Shortage: The part of the product removal transactions that is not tracked by inventory management; this product movement is usually detected only long time after the actual transaction has taken place; it may occur due to e.g. theft or malfunctioning.

Categorization: the process of assigning a product type identifier, e.g. a number or a key to each product item on the basis of the product type of the particular product.

Now, looking at the process of distributing goods from a slightly more theoretical point of view, the tasks in the distribution process are: (i) delivering goods to the client, and (ii) updating the stock's inventory with quantitative and further (e.g. monetary) data.

Retail functionality of small grocery shops is often replaced with different methods of automated vending these days. Probably the most well known of these solutions providing this functionality is a cabinet with an automatic extractor mechanism. Such pieces of equipment are known as vending machines.

A vending machine can have a variety of extractor mechanisms, e.g. a spiral of rigid wire. The spiral is driven by a position controlled motor. The products are placed in the spiral. By applying a certain angle of rotation on the spiral, the goods traverse forward, and the one in the last place of the spiral falls down over the edge of the tray.

Another possible extractor is a bend-like linear conveyor with pegs to push the bottom product of a stack of products aside. The stack then falls back in the place of the extracted product.

In a cabinet-scale environment delivery is not an essential part of the process. As a matter of fact, in traditional product extractor based vending-machines the extractor mechanism is provided with the sole emphasis on supervising the inventory, rather than physically delivering the goods to the client. That is, the most important function of the extracting mechanism is to keep the client, the product, the stock of product items, as well as the payment, if required, under control. At least one extractor is needed for every raw or stack of product items, belonging to a common product type. These extractors are however installed in the internal space of the cabinet, where products could be stored otherwise, using valuable cabinet space volume. Due to the space occupied by extracting mechanisms, storage space is not efficiently utilized in automated vending machines. Extractor mechanisms increase cost, power consumption, and error probability. Also, the speed of extraction is limited, and the transaction is somewhat non-human.

A newer generation of unattended retail systems abandons delivery of product items to the clients, and provides only a stock inventory check, thus ensuring accountability of products.

Such a solution is discussed in e.g. U.S. Published Patent Application No. 2014/0222603 A1 or U.S. Pat. No. 9,536,236 B2, wherein a computer-controlled checkout store with at least one bay is disclosed. Here, a normally locked door is associated with the at least one bay which provides access to items within the at least bay by customers approved previously by a computer of the store outlet. Within the at least one bay, at least one tray is disposed which holds items to be stocked by the bay. A sensor system based on at least one sensor arranged within the at least one tray is configured to detect the removal of an item from the tray and the bay, and identify the removed item when a buyer is removing said item for purchase. Said at least one sensor comprises a light sensor disposed on the at least one tray which is exposed to light when the item is removed from said tray.

An essential part of these and similar solutions is at least one sensor for every set of product items of a common product type. If a tray holds more than one product type, one sensor will be required for each set of product types in order to provide up-to-date inventory records. The sensors need to be connected to the central processing unit, meaning that every shelf has to be fitted with the required number of sensors, as well as the necessary cables. In most case, the sensors are placed in the way of the product movement, which usually makes the system complicated and hard to reconfigure.

Unattended tolls at the checkout points of big stores also attempt to make the vending process automatic in a different configuration. After the client places product items in his basket, he walks to the checkout point. Here he has to scan the barcode of every single product item in his basket, then each product item must be placed on a counter to check its weight. However, the process includes a basket or trolley in order to collect the product items to buy, then remove the product items from the basket one-by-one, scan their barcodes and put them on the tray that is fitted with weight sensors. It is to be emphasized, that the function of the weight sensors here is solely to check if the buyer actually has scanned the relevant product item. The last step is to pack the product items into the client's bag. This process is slow, and leaves the client in a situation where he can miss the barcode scan and weight check of any product. The system identifies the product on a voluntary basis, relying on solely the client's decision weather he scans the product or not. The only purpose of the weight check in this case is to measure the physical mass of the product items. It is to give some self-test to cooperative clients, and not sufficient to detect the action of theft leading to shortage.

Lately, in some merchandising context application this weight check is entirely abandoned. In micromarkets the toll is only fitted with a barcode scanner. After the client completes the consuming process, he has to scan every product item in the basket with the barcode scanner. This, again, works on a voluntary bases, and shortage is usually detected by surveillance cameras and video recorders. The camera system, however, is installed in the room, and therefore installation is not very flexible. Further problems are, that it is a very time-consuming process to inspect the content of the video recordings, it can only be delivered by valuable human power, and it is not very hard to hide any identifiable feature of a person. Moreover, in light of recent regulations, further issues might arise in relation to handling of personal data.

Another solution uses visual processing to categorize the product items. The room is fitted with cameras, and each product item is placed on a tray with a very strictly specified location for each product type. To check whether a product item of a product type leaves the particular shelf, weight sensors are often installed on the trays. The control system tracks the hand of the client to assign the product type to the product items he takes. The disadvantage of this solution is that the room has to fulfill specific requirements of visibility, a camera system has to be installed, and it requires remarkable computing capacity. Also, the shortage is a sole dependent of visibility. The product items of a product type have to be arranged on definite trays which further complicates the installation.

The aforementioned applications of unattended product distributions relate basically to retail systems with some merchandizing process involved. This process incorporates payment, i.e. in order to automate the process, an unattended payment functionality has to be involved as well. It can be a certified bank card, or in community size application a membership card. Online accountancy is also applicable, where the client is identified with a personal code (such as e.g. a PIN, QR, etc.) and his account is checked and updated by a server, on the basis of the identification and in most cases through appropriate data communication connections (such as e.g. the internet, etc.).

Applications of automatized product distribution occur in non-merchandising context, too. In industrial plants it is often an important issue to supply pieces of equipment to employees quickly, but under sufficient control. However to tie up valuable manpower to this task is preferably to be avoided. (The aforementioned mechanisms are a good compromise, and as such these gain popularity in industrial environment.) These applications do not require payment facilities, however these also have to provide accountancy to the management to have a precise inventory on the various pieces of equipment on the stock. Although payment is not involved in the strict sense of word, identification of the client is still necessary.

At present, categorization of a product item in a traditional grocery takes place at the end of the process, when the client walks to the toll and the content of the basket is scanned one by one. Similarly, in case of an automatic toll the client scans the barcode of every product at the time of checkout, thus gathering the quantitative and monetary information. The same categorization of product items in a vending machine takes place when, with a push of a button, the client selects the proper extractor to deliver the product.

If the extractor mechanism and the shop assistant are both abandoned, an unattended application will work on a highly voluntary base. Traditionally, the product is identified at the instant of it's leaving the inventory. However, in an unattended system the time window of product removal is extremely short. One possible solution for that is to rely on the client, who is asked to scan the product—as most automated micromarkets do. Barcode scanners are fast, and easy to use, but without supervision of a shop assistant, the client may fail to scan, thus it is hard to guarantee accurate product identification and correct inventory update. Visual recognition could also be used for product identification, but images of a swift product removal will have to be caught and processed. This would require high-speed cameras, and quite likely, the required computing capacity would go high over the affordable level. Moreover, illumination or visibility will highly deteriorate visual recognition and the quality of images taken.

Consequently, an automated supervisor system and process could help to abandon the space consuming and complicated extractor mechanisms and thus to use the available storage place in a more efficient manner, or the expensive man power.

Moreover, the aforementioned disadvantages of presently applied unattended retail systems should be eliminated or at least significantly alleviated by means of an automated supervisor system and process.

A yet further object of the invention is to provide an automated supervisor system and process with the property of fail-safe product identification and inventory update.

### SUMMARY OF THE INVENTION

The automated supervisor system and process according to the invention run an individual record of each product item (opposed to the accumulated amounts of traditional inventories). Therefore, the invention discriminates individual product identification from product categorization, where individual product identification means discrimination of every single item in the inventory, as opposed to product categorization, that means grouping items of the inventory into product categories. While categorization is sufficient in most application, here individual product identification plays an essential role in the recognition process. It also has the benefit, that every single product item can be assigned information such as expiry date.

The automated supervisor system offered hereby is filled with product items by agents (in particular, the restockers)—persons with permission to execute all the tasks to fill, to manage, and to otherwise control the stock. Once the inventory is filled with product items, said product items are taken out by clients without the need for any further human assistance, at which point the type, quantity, as well as other parameters of the product item, such as e.g. its price, are maintained automatically by the system in subject.

In the automated supervisor system and process according to the invention, product identification takes place at the time the particular product item enters the inventory. Thus, the time-window for product categorization becomes remarkably longer, because said categorization can take place not only at the moment of entry, but during the complete period of time the product is in the cabinet inventory. Since the products' movement is individually tracked related, product type information can be assigned to the product item at any time during its presence in the cabinet inventory. It may open a wide range of recognition, or automatic categorization technologies.

Another advantage of the automated supervisor system and process according to the invention is that if product identification is performed at the moment of stowing/loading product items, it will be assisted by an agent resulting in a lot more predictable situation. Obviously, a staff-member's activity can be controlled to a higher extent than that of a client, and his motivation is to do identification process correctly.

In the present automated supervisor system and process, entry-time product categorization takes place by means of a code reader device forming an integral part of the supervisor system, in particular a barcode scanner, a point code (i.e. a 2D barcode) scanner or a QR code reader, depending on the type of code used on the product item to be categorized. However, the categorization could be done by a multitude of recognition technologies, e.g. by image recognition or a hand-held/mobile device.

The product tracking process in the present automated supervisor system and process is based on an electronic scale, not only capable of measuring weight, but also the position of the product item in the position reference system (i.e. a Cartesian coordinate system) associated with each individual shelf used in the supervisor system on the basis of fundamental physical concepts, i.e. exploiting the fact that each and every product item is in a rest state on the shelf's surface. The position of a product item is maintained in the space segment above the area of the shelf, in said position reference system. The vertical position is calculated from the sequence of arrival of the product items as explained later. Preferably, positioning can also be affirmed by image sensors associated with the individual shelves, thus improving the accuracy, but this is not obligatory.

The automated supervisor system according to the invention assigns an identification key to each and every product item entering the storage space on a shelf. Some additional details can also be stored together with the product identification number, e.g. expiry date, or actual measured weight. These descriptive pieces of information of the product item are collected at the time of entry and also during the period of time the particular product item is located within the monitored segment of space on the shelf. The goal of this process is to categorize the given product item. That is, to determine which product type it belongs to, namely, what product type key is to be assigned to it. This product type key will then point to a product type entry, thus assigning e.g. financial information for e.g. a further accountancy process.

In particular, the above objects are achieved by providing an automated supervisor system to perform automated handling of inventory of products according to claim 1. Possible preferred embodiments of the supervisor system are set forth in claims 2 to 7. The above objects are also achieved by providing a control and data processing unit according to claim 8 and a supervisor method defined by claim 9.

### BRIEF DESCRIPTION OF DRAWINGS

In what follows, the invention and its basic concept are discussed in detail with reference to the accompanying drawings. In the drawings

FIG. 1 is a block diagram of a possible embodiment of an automated supervisor system, its functional components and the information flow in said system, in particular its sensors applied in a possible configuration thereof in operation.

FIG. 2 shows the database structure used in the automated supervisor system of FIG. 1.

FIG. 3 presents schematically the arrangement of the image sensors, weight sensors, and the barcode scanner used in relation to a product tray which serves for storing the product items of various product types.

FIG. 4 illustrates schematically the stowing process, in particular, the phases of the first product entering the shelf space segment.

FIG. 5 illustrates schematically the consuming process, that is, it demonstrates how a product is removed from a shelf; here, the categorization of the product takes place based on the product item position preceding the removal of said product item.

FIG. 6 demonstrates the calculation of a weight position of a product item put onto a tray with two weight sensors in a one-dimensional case [plot (a)], and with four weight sensors in the two-dimensional case [plot (b)].

FIG. 7 is a flowchart representing usage of the automated supervisor system, in particular a cabinet inventory, according to the invention; the flowchart is broken down to the “main loop” illustrated in plot (a), and—depending on the result of user identification—the “restocker mode” [plot (b)] and the “buyer mode” [plot (c)] branches.

FIG. 8 represents schematically a shelf to be used in the automated supervisor system taking the form of a cabinet inventory; here plot (a) shows the sensor bracket assembly with the product tray, that is, the shelf itself, in perspective view, plot (b) illustrates the shelf installed in its position within the cabinet inventory, plot (c) is a top view of the sensor bracket assembly and plot (d) is a sectional view of the sensor bracket assembly along the A-A line.

### DESCRIPTION OF POSSIBLE EMBODIMENTS

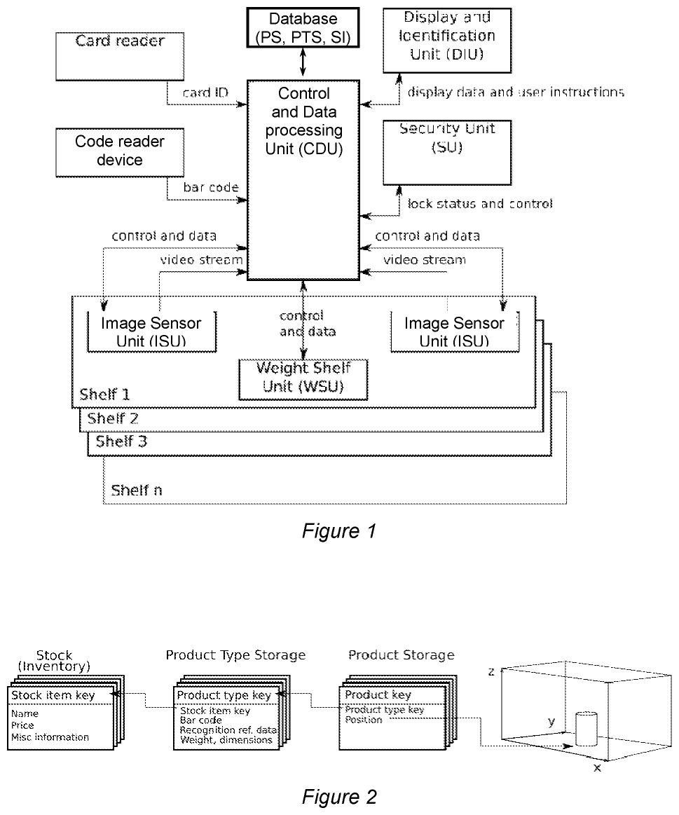

FIG. 1 shows schematically the block diagram of an automated supervisor system, its components and connections, as well as the information flow in said system. The system comprises:
a Control and Data processing Unit (CDU) which functions as the central data processor and control unit of the system. It collects various pieces of information from the additional units and manages all the protocols, including but not limited to a payment protocol, a user verification protocol, etc.
a Weight Shelf Unit (WSU) for each and every storage facility, in particular shelves, of the automated supervisor system, said WSU is connected with four weight measurement sensors that are fitted under the corners of the respective storage facility and configured to process the data of said weight measurement sensors. Upon entry of a product item into a storage facility, the WSU reads the weight change information and the total weight, then sends these data to the CDU. In return, the WSU receives configuration information from the CDU. The WSU can be connected to the CDU through RS232, I2C, LoRaWan or WiFi interfaces, that is, in a wired or a wireless manner.
optionally, an Image Sensor Unit (ISU) for each and every storage facility, in particular the shelves, of the automated supervisor system, wherein said storage facilities can be fitted with a number of these units, preferably each shelf is equipped with two ISUs, basically facing to one another. Each ISU incorporates a camera, but it can also contain a data processing unit to thus help the CDU with pre-processed information. The main function of the ISUs is to capture visual information about the objects while moving inward the shelf space, outward the shelf space or staying on the shelf. Thus, the ISU's main task is to capture and then transfer video stream on the storage facilities to the CDU. In return, the ISU receives control and configuration information from the CDU. The ISUs are preferably connected to the CDU with a WiFi interface, however other types of connections, e.g. a wired one, are also possible. In general, the ISUs will provide (i) (video) data regarding any events that take place in the shelf place (moving an object inward, or moving an object outward), (ii) a visual image of the object for giving an estimation of the product type, (iii) a static visual image of the interior of the shelf. These images can be continuously processed for object location information. Moreover, these images can also be transferred for human monitoring.
optionally, a code reader device, in particular a barcode scanner configured to assist in the classification of product items by using international barcodes, point codes, QR codes or any other similar graphical codes that can be carried by the product item to be classified. Said code reader device is preferably connected to the CDU through an USB interface. It should be here noted, that either the ISUs or the code reader device are present in the automated supervisor system according to the invention to provide the CDU with visual information for identification purposes.
optionally, a card reader configured to read identification cards of different technology and then to send the obtained identification data (ID) to the CDU. Said card reader is preferably connected to the CDU through an RS232C or an USB interface.
a Display and Identification Unit (DIU) configured to provide a user interface to communicate with a user. The DIU also serves as an interface, through which users can input additional verification codes or PIN codes to identify themselves. Said DIU is preferably connected to the CDU through an UTP Ethernet cable or a WiFi interface.
a Security Unit (SU) configured to control a lock mechanism (not shown) of the automated supervisor system according to the invention also fitted with in order to close/open a door to provide access for a user to the storage space on the shelves to stow a product item in or to remove a product item from the supervisor system, as well as to read door or lock status. Said SU is preferably connected to the CDU through an RS485 interface.
a storage medium configured to store various databases used by the automated supervisor system according to the invention for product and product type identification; said storage medium may be provided as a separate unit in data communication with the CDU or it is integrated into the CDU itself.

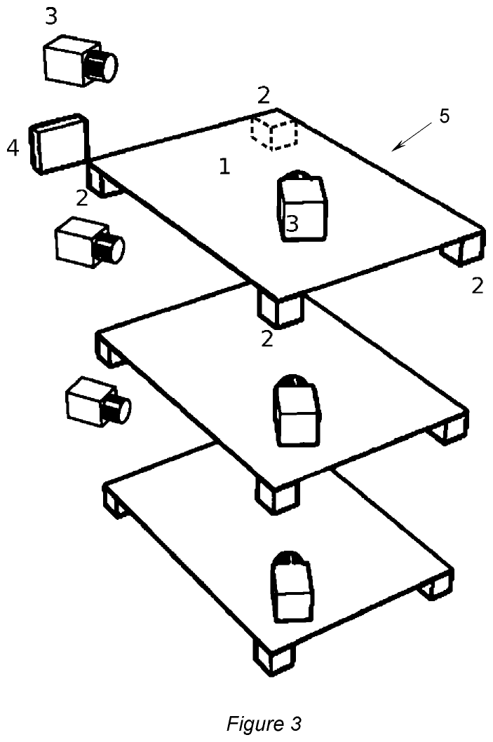

FIG. 2 shows the database structure used in the automated supervisor system according to the present invention. The figure explains the types of the database tables and the relations that link them. The two main tables or files of the database used are Product Storage (PS) and Product Type Storage (PTS).

Product Storage is a database to store information on each individual product item. It includes an identification number and a piece of (x,y,z) position information taken in the position reference system (see below) of a particular shelf space segment that contains the product item with said identification number. Maintenance of this database, practically represented by a file in the storage medium being connected with the CDU, is the task of the CDU.

The PTS is a database to store information on each product category, referred to as Product Type. It incorporates the information needed for the product item recognition process. Maintenance of this database, practically represented by a file in said storage medium being connected with the CDU, is the task of the automated supervisor system itself, through the CDU, preferably by means of an online access and regular, automatic updates. Each entry of the PS contains a Product Type Key as the reference to the corresponding entry in the PTS.

To be able to assign financial information to a certain product item, by the time it leaves the inventory, its Product Type Key has to be determined.

It is logical to separate information with trading or business characteristics, because not all applications are in the same merchandising context. Application specific functions should be separated from the recognition functions, thus application specific data should be separated, too. Regardless of the application, for recognition, it is essential to have the measured weight and the barcode. However, a factory inventory system application, where employees access to tools, will differ from a micromarket application; price is non-existent in case of the first, but necessary in case of the second application. Therefore, such information is collected in a further Stock Inventory (SI), and entries of this database are referred to by the PTS by means of a Stock Item Key.

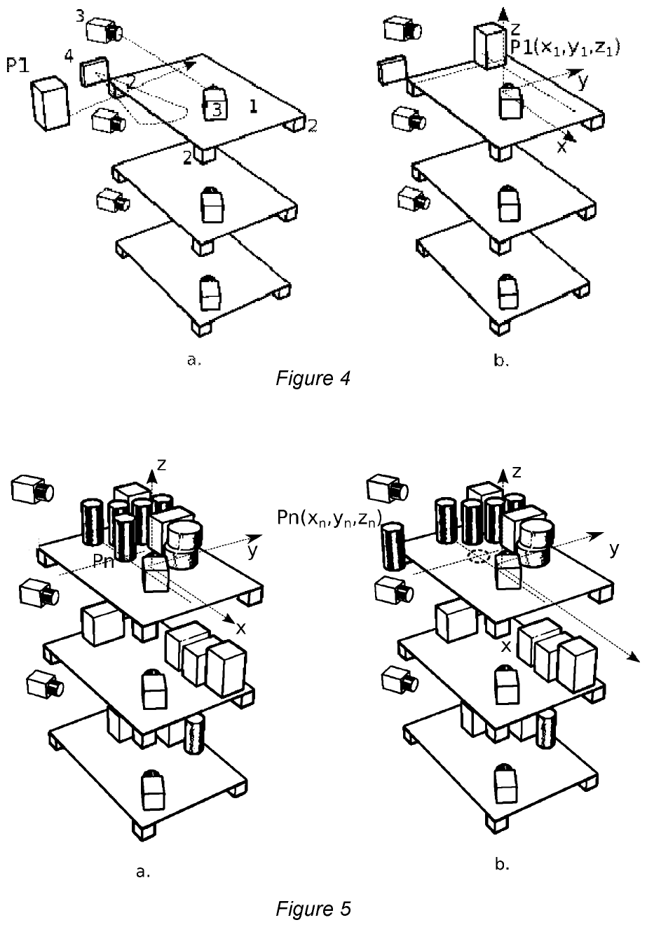

FIG. 3 illustrates schematically a possible practical embodiment of the automated supervisor system according to the invention in the form of a cabinet inventory, comprising at least one shelf 5 to store product items of various product types. The cabinet inventory contains preferentially a multitude of shelves; here, for the sake of simplicity, three shelves 5 are illustrated which are basically identical. Each shelf 5 is a separate storage unit with its own space segment and position reference system (preferably a Cartesian coordinate system), fitted with multimodal sensors. In the minimal configuration, each shelf 5 comprises a product tray 1 that provides the space segment for the product items to be stored within the cabinet inventory, and is equipped with weight measurement sensors 2 and image sensors 3. Optionally, each shelf 5 is fitted with a code reader device 4, in particular a barcode, a point code or a QR code scanner. In a possible further embodiment, only one code reader device 4 is applied per cabinet inventory, i.e. only one of the shelves 5 is equipped with the core reader device 4. Said weight measurement sensors 2 are arranged under each corner of every shelf 5; considering shelves 5 of rectangular shape, there are four weight measurement sensors 2 used per shelves 5. Said image sensors (or ISUs) are arranged preferably in the following manner: two image sensors 2 is affixed at the front or back side of each and every shelf 5. The location of the cameras of the image sensors 2 is such, that they can see the product items from the moment of entering the shelf space segment.

The product tray 1 and the weight measurement sensors 2 are fitted to each shelf 5. The image sensors 3 and the code reader device 4 can be used together, or alternatively. Their purpose is to deliver the product categorization from the time of entry to the time of consummation. The code reader device 4 can also have a secondary function: it can be a safety backup equipment in consumer mode, if the individual product identification has a high estimated error. In such unfortunate cases, the supervisor system will display a message to the client asking him to confirm the product identification by scanning the code carried by the product item under investigation. The image sensors 3 can also be used with other functionality, namely they can assist the positioning process, too. Thus, the automated supervisor system according to the invention works with multimodal sensors.

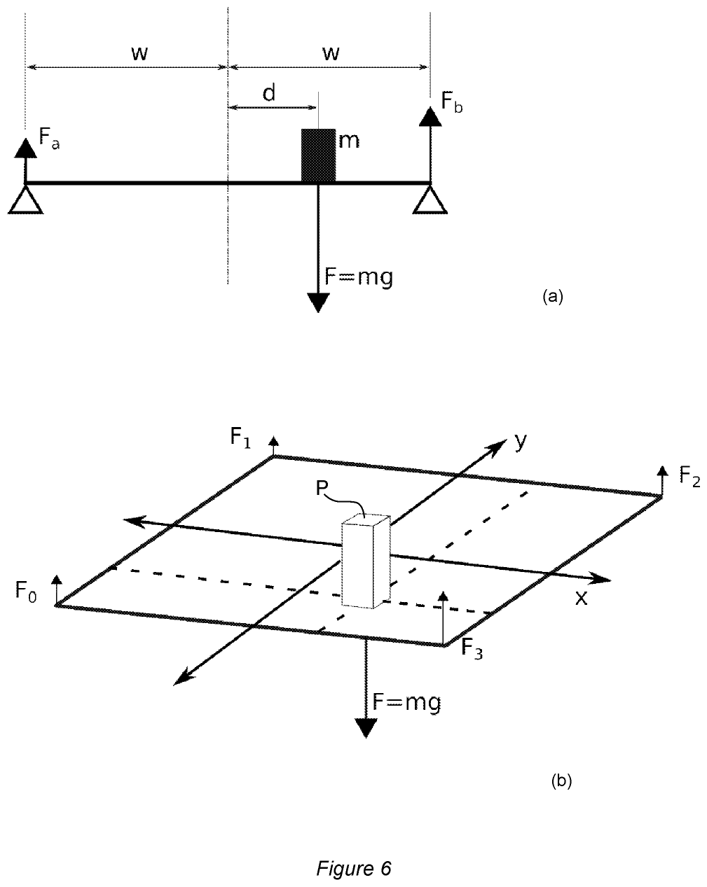

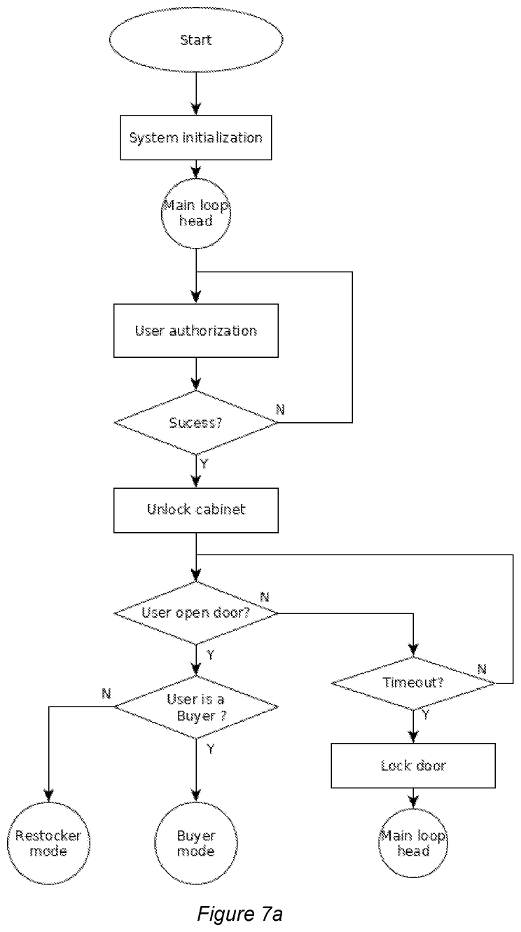

In what follows, categorization process of the automated supervisor system according to the invention is explained in detail with reference to FIG. 4 and FIG. 5.

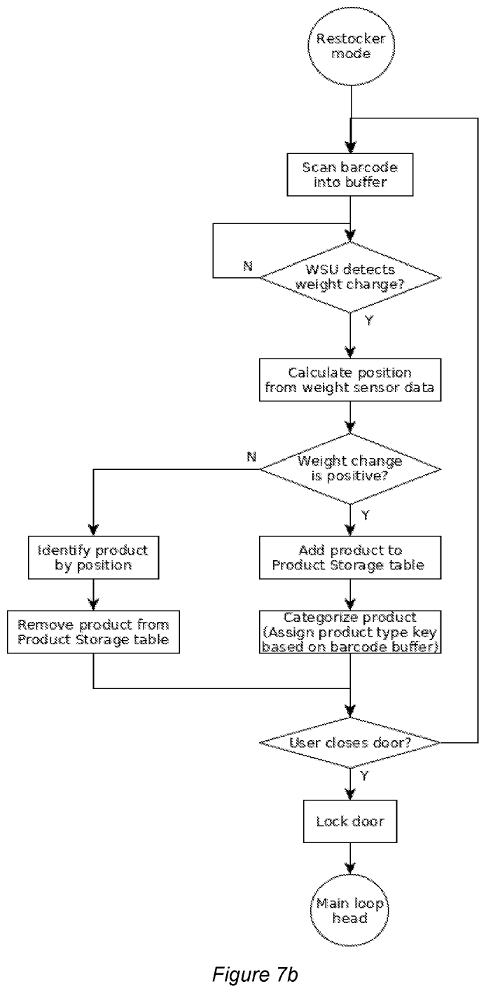

In the automated supervisor system described here categorization of a product item P1 starts when said product item P1 is stowed into the automated supervisor system, i.e. its cabinet inventory (FIG. 4a). When the product item P1 is placed on the product tray 1, its position is determined from the information provided by the weight measurement sensors 2 arranged under the corners of the tray (FIG. 4b). Details of said position determination is discussed later with reference to FIG. 6.

While the cabinet inventory is loaded with products (FIG. 5a), every single product item position is determined in the Cartesian coordinate system associated with the respective shelf, and recorded in the PS database. As shown in FIG. 5a, the cabinet inventory is loaded at a certain level.

After the buyer is granted access to the inside of the cabinet inventory, he takes out e.g. product item Pₙ. When the product item Pₙ leaves the shelf space segment (FIG. 5b), the CDU will identify the individual product item Pₙ on the basis of its stored ex-position information. At this point, the product has been already categorized, namely its entry into the PS has already been assigned a product type from the PTS database. At this time the product type is sent for further processing (basket, credit collection, accountancy). At the moment, when a user removes a product item Pₙ from a shelf in the supervisor system (FIG. 5b), the particular product item's position will determine its individual identification key, which will then provide the assigned product type together with the related monetary and other details that had been assigned to it in the database.

FIG. 6 explains how to calculate the position of a product item put onto a product tray of a shelf within the supervisor system according to the invention based on four pieces of weight sensors fitted under the corners of said shelf. To this end, the concept of equilibrium of the product item is exploited.

The two-dimensional position is derived from a distance calculated in the vertical direction and a distance calculated in the horizontal direction.

In a one-dimensional case, shown in FIG. 6(a), distance “d” measured from the center of the Cartesian coordinate system (that is, the position reference system) associated with the shelf can be calculated as follows: the balance only stands—in other words the system is stationary or in rest—if the vectorial sum of the forces exerted by a product P is zero (see equation (1) below) and the sum of the torques emerging due to said product P is also zero (see equation (2) below).

This means that

F=Fₐ+F_{b} where F=mg from the mass of the object on the tray. (1)

and

(w+d)Fₐ+(−1)(w−d)F_{b}=0 (2)

We can use (2) to determine the d position:

$$d = w \frac{( {F}_{b} - {F}_{a} )}{{F}_{b} + {F}_{a}}$$

In the two-dimensional case, shown in FIG. 6(b), the above calculation using the sums of the load-cell pairs on the sides as Fₐ and F_{b} can be executed. In particular,

Horizontal (x) position:

Fₐ=F₀+Fₜ

F_{b}=F₂+F₃

Vertical (y) position:

Fₐ=F₀+F₃

F_{b}=F₁+F₂

To detect individual products P, the superposition theorem is made use of. That is, the system in subject is linear. Therefore, any force applied to a point of the two-dimensional coordinate system of each tray will exerts its effect independently of whether or not other forces also act on the tray.

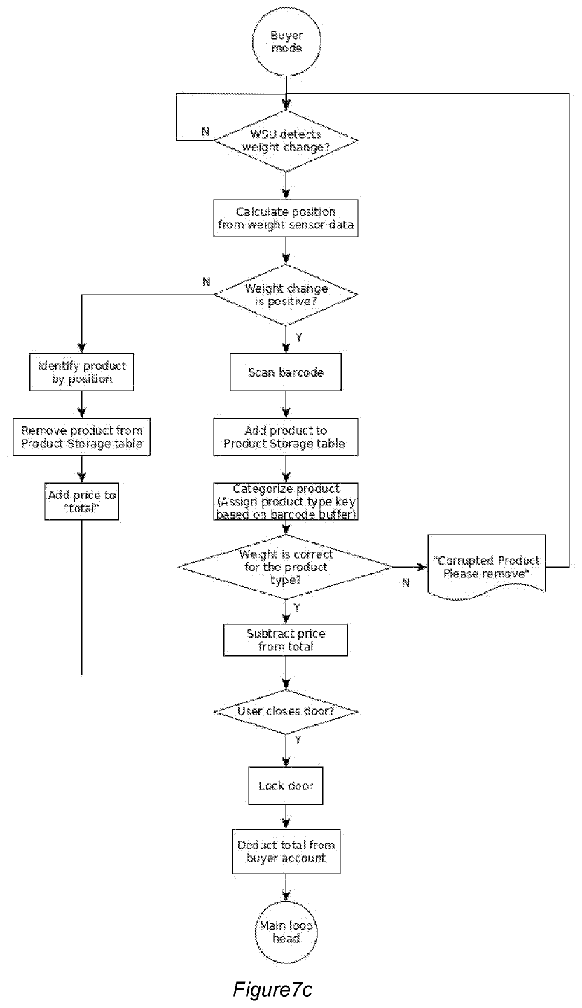

FIG. 7 is a flowchart that presents how to use the automated supervisor system, in particular a cabinet inventory, according to the invention.

In FIG. 7 the categorization process is presented in a merchandise context application. The process is controlled by the program of the CDU.

The “main loop” is shown in FIG. 7a, according to which the cabinet inventory first authenticates the user. This authentication has to be performed by an external server, which is not part of the present document. This authentication will contain the permission and the role of the user (buyer or restocker). If the user is granted permission, the CDU sends the SU an “unlock cabinet” instruction. The CDU then waits for the information of the cabinet's own control mechanism from SU. If the user opens the door within the timeout period, the system determines if the permission was granted to a buyer or a restocker, and continues accordingly in “restocker mode” (FIG. 7b) or in “buyer mode” (FIG. 7c)

The “restocker mode” of the supervisor system according to the invention is illustrated in FIG. 7b, according to which in the “restocker mode”, the agent with the restocker role stows the product items into the inventory (see also FIGS. 4a and 4b). When an agent stows new products in the inventory, the agent scans the product with the barcode scanner. The barcode is stored in a buffer for later use. The system then waits for the weight-change event. This event will be detected by the WSU by means of the weight sensors. (If the optional image sensors are installed, the product then will cross the line between the image sensors. The image sensors send a video stream to CDU, and the program running on the CDU will start visual tracking of the object.)

Once weight change is detected by the WSU from the weight measurement sensors data the WSU will send the measurement and the position information to CDU. The (x,y) Cartesian coordinates are calculated from the change in the total weight and the transition of the gravity center of the shelf (See algorithm later.)

An optional (z) coordinate can be calculated by CDU based on the order the products arrived in the inventory. This can be represented by a time-stamp, or as a simpler implementation the incremented product key can also be used. The program presented by this flowchart does not deliver this functionality.

After the event of weight change takes place, the process determines if it is positive (i.e. increase) or negative (i.e. decrease).

In case of a positive weight change, (restocker has put a product item onto the tray) the product item is added to the Product Storage table. The next step is categorization, which will happen based on the barcode that has been stored in the barcode buffer. At this point, the restocker can proceed with placing further products of the same product type onto the tray, because the content of the barcode buffer can be reused to categorize the next product item.

In case of a negative value, (restocker has removed a product from the tray) the product is one that has been in its position due to a previous fill phase. Therefore its entry in the Product Table has been categorized, and contains the Product Type key. This product is now removed from the Product Storage based on its position.

Here, the agent is allowed to place the product on the tray without having it scanned, by CDU assuming it is the next product of the same product type of the previous product item.

In this configuration the CDU attempts to categorize the product with a barcode. If the optional image sensors are installed, the supervisor system may attempt to categorize the product through visual recognition. In case this attempt fails, the agent will get a signal, and recognition can be improved by the barcode scanner retroactively.

The same operation will be executed on every consequential product loaded in the inventory. The end of the process is indicated by the restocker closing the door. The application locks the door, and returns back to the main loop, thus any further access to the inventory can only be done after a new user identification.

The “buyer mode” of the supervisor system according to the invention is illustrated in FIG. 7c, according to which when the identification of the user ends with a “buyer”, the consumer process is as follows.

In the merchandising context permission is granted to the buyer after the server declares the buyer has sufficient funds.

When the buyer removes a product item from the tray, it will induce a weight change event. At the moment he lifts the product the weight sensors send measurement information to the WSU, which than calculates the change in total weight, and the transition of the gravity center of the shelf space segment—algorithm see later. (The position information can also be amended by the optional image sensors.)

After the weight change event happens the process determines if it is positive or negative.

In case of a negative weight change (the buyer consumed a product) the product is looked up from the Product Storage Table by its position. It will determine the assigned Product Type related and Inventory information.

The product will be removed from the Product Storage Table, and the price will be added to the buyer's total payment.

If the weight change is negative (the buyer places a product back on the tray), the buyer is asked to scan the barcode, thus it will be categorized. An additional weight check is executed, if the product has the required weight. If not, an error message is displayed for the buyer. If the test passes, the product will be put back to the Product Storage Table with its new position, and the price will be subtracted from the user's total payment.

From the (x,y) information and the sequence of entering, an optional z position can be calculated. This application does not contain this possibility.

When the buyer closes the door of the stock, or otherwise signals the end of the transaction, the total payment will be deducted from his debit, and the process returns to the main loop.

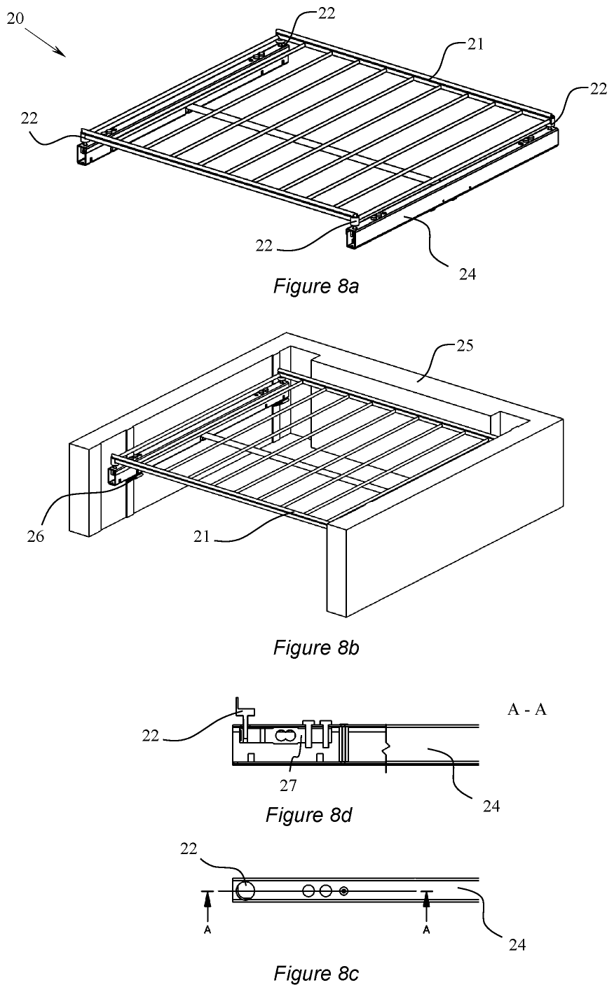

FIG. 8 represents schematically the mechanical structure of a preferred embodiment of the storage facility, that is, a shelf 20 to be used in the automated supervisor system taking the form of a cabinet inventory 25. In FIG. 8, plot (a) shows a sensor bracket assembly 24 with a product tray 21, that is, the shelf 20 itself, in perspective view. Plot (b) illustrates the shelf 20 installed in its position within the cabinet inventory 25, wherein the sensor bracket assembly 24 is positioned between hooks 26 of the cabinet inventory 25 and the product tray 21. The hooks 26 are such parts of the cabinet inventory 25 that are used to hold the product tray 21 in a traditional cabinet. Each of said hooks 26 is usually arranged in a configurable position. Plot (c) is a top view of the sensor bracket assembly 24, while plot (d) is a sectional view of the sensor bracket assembly 24 along the A-A line, with a tray holder 27 that is mounted into the respective weight measurement sensor 22 fitted onto said sensor bracket assembly 24. The sensor bracket assemblies 24 provide rigid structures for holding the weight measurement sensors 22.

In particular, the shelf 20 comprises (from top to down in FIG. 8a) a product tray 21, weight measurement sensors 22 and a pair of sensor bracket assembly 24. Said weight measurement sensors 22 are fitted at both end portions of the sensor bracket assemblies 24 in such a way that in the assembled state of the shelf 20 the weight measurement sensors 24 are located just under the corner portions of the product tray 21 (close to the edges thereof). In particular, each corner of the product tray 21 rests on a respective weight measurement sensor 22 in order the latter could perform weight measurements when a new product item is put on the surface of said product tray 21 that serves to hold the product items within the cabinet inventory 25.

The sensor bracket assemblies 24 are essential components of the shelves 20; other systems presently use weight measurement sensors only to determine the weight of the products put onto the shelf, as opposed to the automated supervisor system according to the invention which uses the weight sensors to determine both the position and the weight of said products.

1. A supervisor system to perform automated handling of inventory of product items, comprising:
a control and data processing unit, CDU, configured to perform central data processing to identify product items and control over system components;
at least one storage facility in the form of a product tray having upper face and lower face, the upper face forming storage space, the storage facility being configured to receive and hold product items in said storage space, the product tray being fitted with a minimum of four weight measurement sensors arranged in contact with said lower face, the sensors being adapted to collect weight measurement data of the tray with the product items in the storage place;
a weight shelf unit, WSU, configured to process weight measurement data and thereby calculate position information for each product item from said weight measurement data when a particular product item enters the inventory, said weight measurement data being provided by said weight measurement sensors;
at least one imaging unit configured to capture and transfer visual information on at least one of the product items to the CDU for said product identification performed by the CDU;
a database stored on a storage medium associated with the CDU, comprising:
representation of every individual product item in the inventory through an individual product key for identification of each product item,
the position information of each product item provided by the WSU, and
an individual product type key for automated categorization of each product item.

2. The supervisor system according to claim 1, wherein the position information is represented by a pair of distances in orthogonal directions over the upper surface of the product tray relative to a reference point, the distances being determined by exploiting the concept of balance of forces and torques exerted by the product item onto the upper face of the product tray at the location where said product item contacts said upper face when enters the storage place.

3. The supervisor system according to claim 1, wherein the at least one imaging unit are in the form of image sensor units, ISU, associated in pairs with each of the at least one storage facility in opposing spatial positions of a respective storage facility and configured to continuously monitor the storage place of the respective storage facility to obtain said visual information, said visual information chosen from a group consisting of video streams and static visual images.

4. The supervisor system according to claim 1, wherein the at least one imaging unit is in the form of at least one code reader device configured to read a code provided on the product item to obtain said visual information as an image of the code.

5. The supervisor system according to claim 4, wherein the code reader device is chosen from the group consisting of barcode readers, point code readers and QR code readers.

6. The supervisor system according to claim 1, further comprising a card reader configured to obtain user identification data by reading a user identification card and transfer said identification data to the CDU for user identification performed by the CDU to provide access for the user identified to the inventory of product items.

7. The supervisor system according to claim 1, further comprising a security unit, SU, and a lock mechanism, the SU is configured to control the lock mechanism, the lock mechanism is configured to open/close the storage place of the at least one storage facility in response to respective command of the SU to enable/disable access to the inventory of product items.

8. A control and data processing unit, CDU, to be used in the supervisor system according to claim 1, the CDU being configured
to categorize every product item that enters a storage space in the interior of the inventory through any of automatic identification and visual product recognition;
to monitor the resting position of each product item in the storage space of the at least one storage facility provided in the form of shelves in the following way:
when the weight measurement sensors detect that the product is placed on the shelf, the CDU records the resting position of the product in said database in record of the particular product item in the following way:
the (x,y) coordinates are calculated by the WSU from the change in the total weight and the transition of the gravity center of the shelf;
the (z) coordinate is calculated by CDU based on the order the products arriving in the inventory, the order being represented by a time-stamp;
to maintain the product type category of the individual product by adding the key into a record that represents the product item being just monitored in said database;
to look up the product type key when a product item is lifted from the shelf in the following way:
when the weight sensors detect that a product is lifted from the shelf, the CDU detects the position where the product was removed in the following way:
the (x,y) coordinates are calculated by WSU from the change in the total weight and the transition of the gravity center of the shelf;
the (z) coordinate is calculated by CDU based on the order the product items have arrived into the inventory, the order being represented by a time-stamp;
the CDU looks up the detected (x,y,z) position of the removed product item in the database and identifies which product items it belongs to; and
from the individual product record, the CDU identifies the product category.

9. A supervisor method to perform automated handling of inventory of product items, comprising using the supervisor system of claim 1 for handling the inventory of product items in combination with a control and data processing unit, CDU, to be used in the supervisor system according to claim 1, the CDU being configured
to categorize every product item that enters a storage space in the interior of the inventory through any of automatic identification and visual product recognition;
to monitor the resting position of each product item in the storage space of the at least one storage facility provided in the form of shelves in the following way:
when the weight measurement sensors detect that the product is placed on the shelf, the CDU records the resting position of the product in said database in record of the particular product item in the following way:
the (x,y) coordinates are calculated by the WSU from the change in the total weight and the transition of the gravity center of the shelf;
the (z) coordinate is calculated by CDU based on the order the products arriving in the inventory, the order being represented by a time-stamp;
to maintain the product type category of the individual product by adding the key into a record that represents the product item being just monitored in said database;
to look up the product type key when a product item is lifted from the shelf in the following way:
when the weight sensors detect that a product is lifted from the shelf, the CDU detects the position where the product was removed in the following way:
the (x,y) coordinates are calculated by WSU from the change in the total weight and the transition of the gravity center of the shelf;
the (z) coordinate is calculated by CDU based on the order the product items have arrived into the inventory, the order being represented by a time-stamp;
the CDU looks up the detected (x,y,z) position of the removed product item in the database and identifies which product items it belongs to; and
from the individual product record, the CDU identifies the product category.

10. The supervisor system according to claim 2, wherein the at least one imaging unit are in the form of image sensor units, ISU, associated in pairs with each of the at least one storage facility in opposing spatial positions of a respective storage facility and configured to continuously monitor the storage place of the respective storage facility to obtain said visual information, said visual information chosen from a group consisting of video streams and static visual images.

11. The supervisor system according to claim 2, wherein the at least one imaging unit is in the form of at least one code reader device configured to read a code provided on the product item to obtain said visual information as an image of the code.

12. The supervisor system according to claim 2, further comprising a card reader configured to obtain user identification data by reading a user identification card and transfer said identification data to the CDU for user identification performed by the CDU to provide access for the user identified to the inventory of product items.

13. The supervisor system according to claim 3, further comprising a card reader configured to obtain user identification data by reading a user identification card and transfer said identification data to the CDU for user identification performed by the CDU to provide access for the user identified to the inventory of product items.

14. The supervisor system according to claim 4, further comprising a card reader configured to obtain user identification data by reading a user identification card and transfer said identification data to the CDU for user identification performed by the CDU to provide access for the user identified to the inventory of product items.

15. The supervisor system according to claim 5, further comprising a card reader configured to obtain user identification data by reading a user identification card and transfer said identification data to the CDU for user identification performed by the CDU to provide access for the user identified to the inventory of product items.

16. The supervisor system according to claim 2, further comprising a security unit, SU, and a lock mechanism, the SU is configured to control the lock mechanism, the lock mechanism is configured to open/close the storage place of the at least one storage facility in response to respective command of the SU to enable/disable access to the inventory of product items.

17. The supervisor system according to claim 3, further comprising a security unit, SU, and a lock mechanism, the SU is configured to control the lock mechanism, the lock mechanism is configured to open/close the storage place of the at least one storage facility in response to respective command of the SU to enable/disable access to the inventory of product items.

18. The supervisor system according to claim 4, further comprising a security unit, SU, and a lock mechanism, the SU is configured to control the lock mechanism, the lock mechanism is configured to open/close the storage place of the at least one storage facility in response to respective command of the SU to enable/disable access to the inventory of product items.

19. The supervisor system according to claim 5, further comprising a security unit, SU, and a lock mechanism, the SU is configured to control the lock mechanism, the lock mechanism is configured to open/close the storage place of the at least one storage facility in response to respective command of the SU to enable/disable access to the inventory of product items.

20. The supervisor system according to claim 6, further comprising a security unit, SU, and a lock mechanism, the SU is configured to control the lock mechanism, the lock mechanism is configured to open/close the storage place of the at least one storage facility in response to respective command of the SU to enable/disable access to the inventory of product items.
